(19) United States
(12) Patent Application Publication
(10) Pub. No.: US 2004/0246652 A1
(43) Pub. Date: Dec. 9, 2004

(54) Vibrarion-resistant capacitor and method for producing the same

(76) Inventors: Norbert Will, Heidenheim (DE); Rainer Hebel, Heidenheim (DE); Wilhelm Schweikert, Heidenheim (DE); Klaus Danzer, Merklingen (DE); Rudolf Wittmann, Heidenheim (DE)

Correspondence Address: FISH & RICHARDSON PC, 225 FRANKLIN ST, BOSTON, MA, 02110, US

(21) Appl. No.: 10/490,718

(22) PCT Filed: Sep. 27, 2002
(86) PCT No.: PCT/DE02/03663

(30) Foreign Application Priority Data
Sep. 28, 2001 (DE) 101 48 242.6
Oct. 24, 2001 (DE) 101 52 342.4

(51) Int. Cl. H01G 2/00

(52) U.S. Cl. 361/271

(57) ABSTRACT

A capacitor with better resistance to vibration, and a method for its production, are proposed. For this purpose, a capacitor winding (10) is introduced into a housing (5), such that it is partially interlocked with the housing. After this, the capacitor winding is impregnated, during which process it expands and additional pressure forces occur between the winding and the cover wall, which fix the capacitor in the horizontal direction. In a final method step, the capacitor is then fixed vertically between a cover (15) and the base of the cup-shaped housing, by pinching.

Electrolytic capacitors are generally in the form of an arrangement comprising, for example, an aluminum cathode sheet and an anode sheet composed of aluminum, which has a dielectrically acting oxide layer that is applied directly to the sheet by electrochemical processes. A spacer is located between the sheets, for example in the form of a single layer or multiple layer composed, for example, of paper, which is impregnated with an electrolyte solution. The arrangement is normally in the form of a winding which is applied around a pin which is installed in a cup, for example composed of aluminum. A cover, on which electrical connections are arranged, closes the cup at the top. The connections are electrically conductively connected to the capacitor winding.

Electrolytic capacitors with the connections that have been mentioned are frequently used in automotive applications, for example in the vicinity of the engine in passenger cars, where they are subject to very severe mechanical vibration. Particularly when subject to severe vibration loads, the capacitor winding can move relative to the capacitor cup and the electrical connections which are firmly connected to it. There is therefore a risk of the electrical connections between the winding and the cover of the cup becoming loose, so that the electrolytic capacitor loses its electrical function.

Damping elements are generally fitted to the outside of the capacitor cup, for example elastomer panels or foam materials, which are intended to damp excessive vibration of the electrolytic capacitor. However, these measures are very complex and expensive. Another conventional damping measure is to inject an encapsulating compound, for example a plastic, between the capacitor winding and the capacitor cup, and this prevents the capacitor winding from moving relative to the cup. However, this design has the disadvantage that an encapsulating compound is also at the same time injected between the winding and the cup base. Since the encapsulating compound must be electrically insulating, it is also not a good thermal conductor, and this leads to a deterioration in the thermal heat dissipation from the winding to the cup. Furthermore, the undefined thickness of the encapsulation on the base makes it difficult to fix the winding in the horizontal direction, so that complex manufacturing steps are required.

The aim of the present invention is therefore to specify a method for production of a vibration-resistant electrolytic capacitor, and to specify a vibration-resistant electrolytic capacitor which avoids the stated disadvantages.

According to the invention, this aim is achieved by a method as claimed in claim 1. Further advantageous refinements of the method, as well as an electrolytic capacitor with better resistance to vibration, are the subject matter of further claims.

The method according to the invention is distinguished by three method steps A) to C). In a first method step A), a capacitor winding is inserted into a cup-shaped housing which has a base and a cover, such that it is at least partially interlocked with the wall of the housing, that is to say the capacitor winding must make contact with the housing at least in places. The capacitor winding is in this case somewhat longer than the distance available for it between the base and the lower edge of the cover. In a second method step B), the capacitor winding is then impregnated with a liquid, during which process it expands. This results in strong pressure forces from the capacitor winding on the cup, which are sufficiently strong to prevent any relative movement between the winding and the housing in the event of vibration. This makes it possible to ensure that the capacitor winding fills the space available for it in the housing to the maximum extent, and is thus fixed in the housing in the horizontal direction. The capacitor winding is advantageously impregnated with an electrolyte solution, which is also at the same time required for operation of the capacitor, in the method step B).

In a final method step C), the cup-shaped housing is then closed at the top by a cover such that the capacitor winding is fixed between the cover and the base of the cup-shaped housing by pinching (axial fixing).

The axial fixing can be achieved by the winding being somewhat longer than the distance available for it between the base of the capacitor cup and the lower edge of the cover of the capacitor. Thus, for example, areas of the spacer, the paper layer, may project from the capacitor winding and may be crushed by the cover while the housing is being closed, thus resulting in the winding being fixed.

The method according to the invention thus results in the capacitor winding being braced axially in its axial direction in the capacitor housing and on the other hand being fixed horizontally, that is to say radially, by subsequent impregnation of the capacitor winding after it is located in the housing.

In a further advantageous refinement of the method, fixing elements, for example in the form of indentations in the housing, may be produced in a method step A1) which is carried out after the method step A), such that they additionally fix the capacitor winding in the housing. This can be achieved, for example, by beads being pressed from the outside into the housing by means of molding, with these beads somewhat pinching the capacitor winding. This further method step, which may be carried out before the impregnation of the winding, has the advantage that, as a result of the expansion of the winding during its subsequent impregnation, the fixing forces become even stronger, thus resulting in further, additional fixing of the capacitor winding in the housing. Capacitors which additionally have these indentations can withstand even very severe vibration loads. However, it is also possible to carry out the method step A1) after the impregnation of the capacitor winding and the closure of the housing, that is to say after the method steps B) or C).

A capacitor whose external diameter corresponds to the internal diameter of the housing is advantageously used in the method step A). This makes it possible to ensure that, after the capacitor winding has been pushed into the housing in the method step B), it is fixed very well in the housing during the impregnation of the capacitor winding.

It is also possible to use a housing on whose inner wall fixing elements are arranged in the method step A). These fixing elements may, for example, be in the form of ribs which project into the interior of the housing. In this case, it is possible for the ribs to run parallel to the axis of the capacitor winding in the inner wall of the housing, or for them to run, for example partially or completely around the inner circumference of the capacitor housing and thus be arranged at right angles to the axis of the capacitor winding. It is also possible, by way of example, to fit fixing elements in the form of pins.

If fixing elements are present, these bound a space in the interior of the housing which is available for accommodation of the capacitor winding. This space has a smaller diameter than that space which would be available to the capacitor winding if there were no fixing elements. Thus, in this case, it is advantageous for the external diameter of the capacitor winding to correspond to the diameter of the space in the housing which is bounded by the fixing elements. This makes it possible to ensure that, once the capacitor winding has been inserted, the fixing elements bound the outer circumference of the winding and that this expands during the impregnation process (method step B), and is clamped in between the fixing elements.

Furthermore, as has already been described above, the capacitor winding (10) is somewhat longer than the distance available for it between the cup base and the lower edge of the cover, so that, when the capacitor housing is closed by the cover, the capacitor winding is also additionally fixed by crushing.

The housing with the associated fixing elements may, for example, be produced in a single method step in a method step A1) which is carried out before the method step A). In this case, it is possible, for example, to use the extrusion molding method. The extrusion molding method is generally a so-called cold forming method in which a blank is shaped in the cold state by means of a die to form the cup-shaped housing with the associated fixing elements. However, it is also possible to fit the fixing elements retrospectively in the interior of the housing, as separate components.

The method according to the invention as well as an electrolytic capacitor according to the invention will be explained in more detail in the following text with reference to exemplary embodiments and figures, in which:

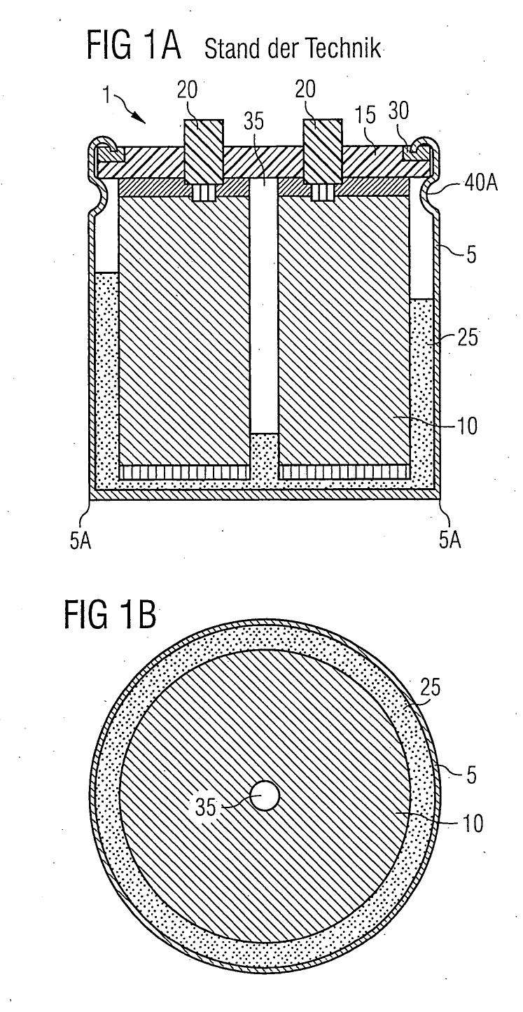

FIGS. 1A and 1B show a schematic cross section through, and a plan view of, an electrolytic capacitor according to the prior art, in which an encapsulating compound is used for fixing the capacitor winding.

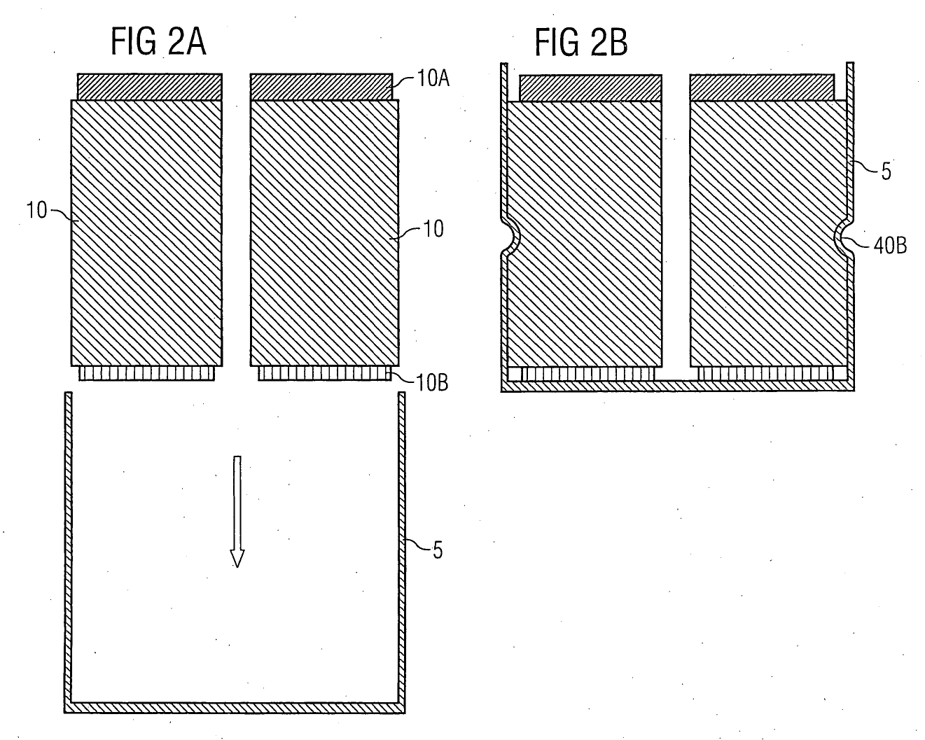

FIGS. 2A and 2D show an example of a method according to the invention in which the further, advantageous method step A1) is also shown in addition to the method steps A) to C) according to the invention.

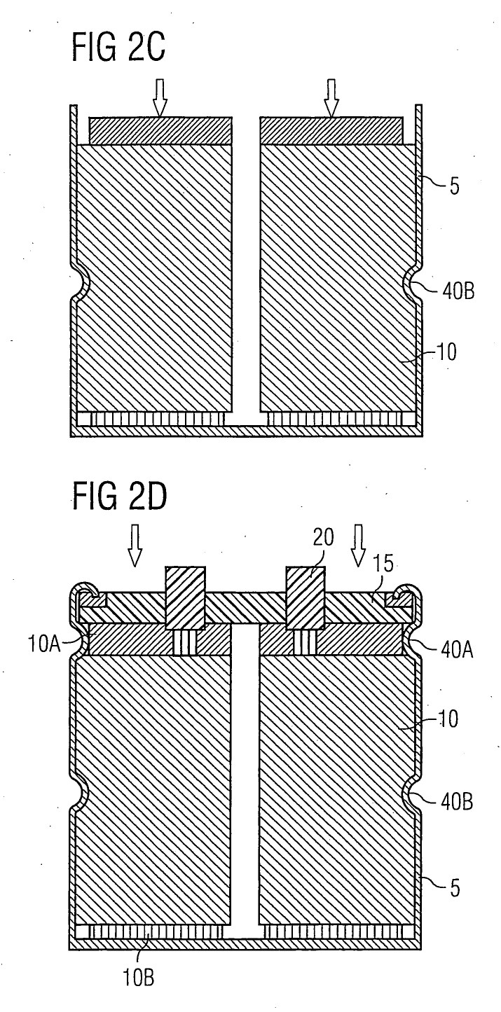

FIGS. 3A and 3B show a schematic cross section through, and a plan view, of a variant of a capacitor according to the invention with fixing elements.

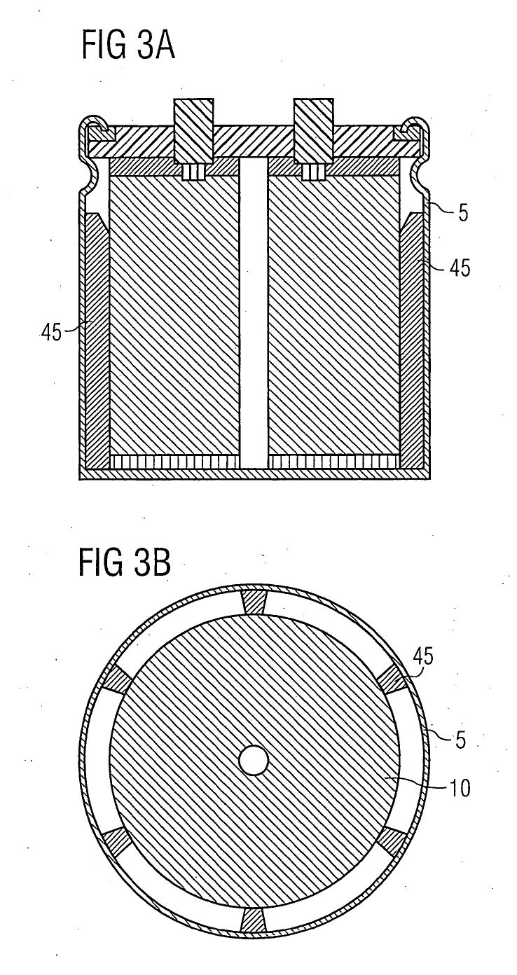

FIGS. 4A and 4B show a schematic cross section through and a plan view of ways to dissipate heat from the capacitor winding to the housing.

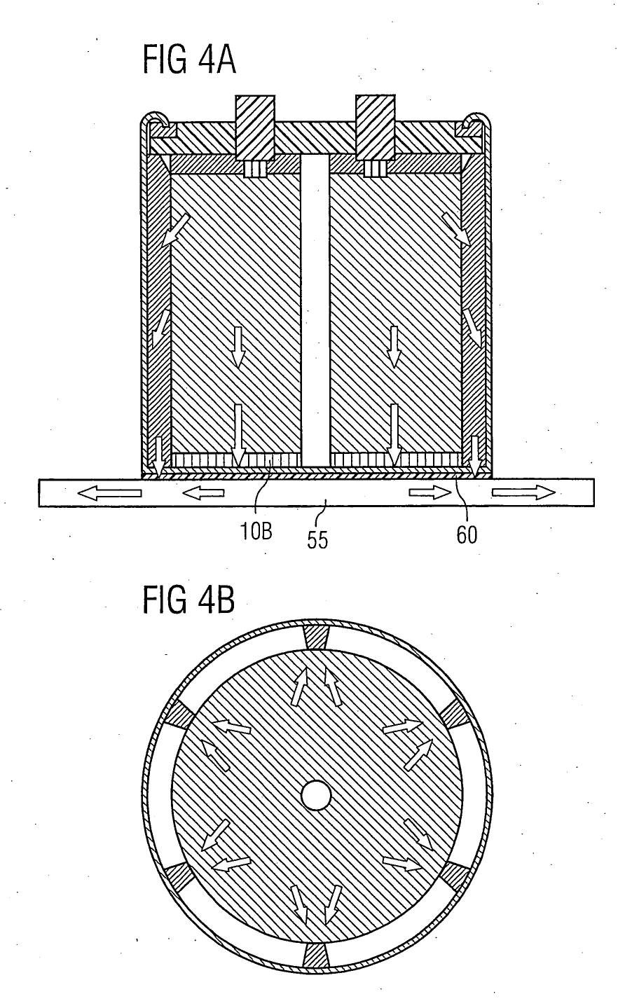

FIG. 5 shows a schematic cross section through the ways (which are bounded in a disadvantageous manner) for heat dissipation between the capacitor winding and the housing in conventional capacitors according to the prior art.

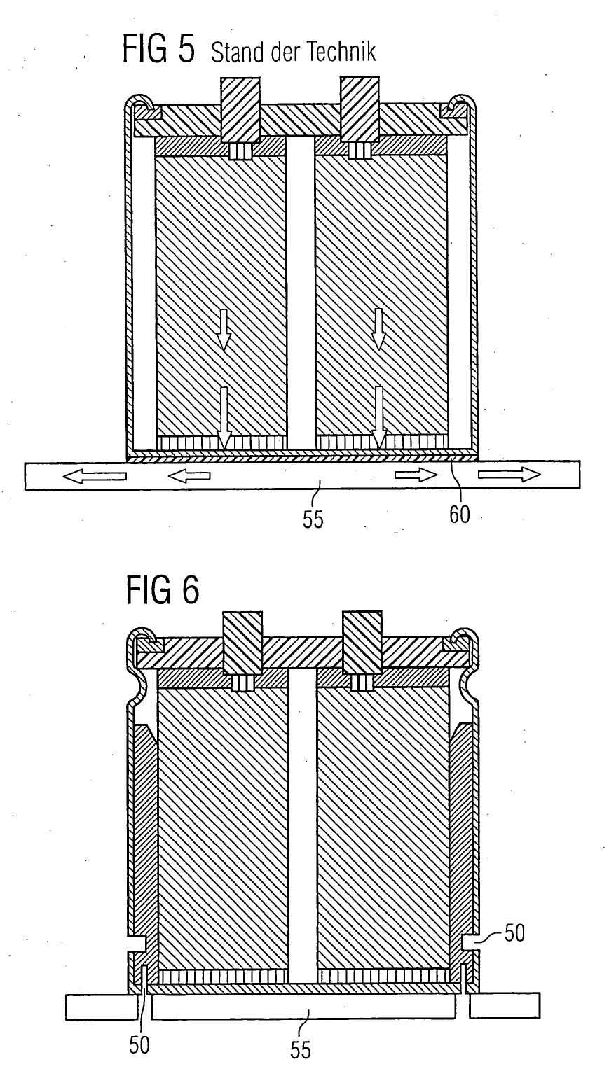

FIG. 6 shows a further embodiment of a capacitor according to the invention, with depressions for mounting it on a plate.

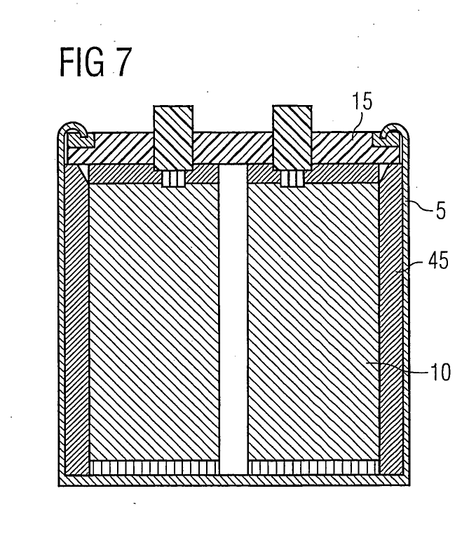

FIG. 7 shows a further refinement of the capacitor according to the invention with a contact bead for the cover.

FIG. 1A shows a schematic cross section through a conventional capacitor 1 with an encapsulating compound 25 which fixes the capacitor winding 10 in the housing 5. As can be seen, not only is the encapsulating compound arranged between the wall of the housing 5 and the capacitor winding, but the encapsulating compound, an electrically insulated material (which at the same time is also poorly thermally conductive owing to these insulating characteristics) also covers the base of the housing cup 5A. This has the disadvantage that it impedes heat dissipation from the capacitor winding via the base of the housing cup. At the top, the cup-shaped housing 5 is closed by a cover 15, through which electrical connections 20 are passed which make electrical contact with the capacitor winding. A rubber ring 30 is used to close the housing in a sealed manner in the area of the cover. Furthermore, a contact bead 40A may be provided, on which the cover 15 rests. In the center of the capacitor winding, there is a hole 35 in which the pin (which will be removed later) for the capacitor winding was located during the winding process.

FIG. 1B shows a plan view of the conventional capacitor as illustrated in the form of a cross section in FIG. 1A. As can be seen, the encapsulating compound 25 which fixes the winding in the housing is located between the capacitor winding 10.

FIG. 2A shows a schematic cross section through one variant of the first method step A) according to the invention. As can be seen, a capacitor winding 10 whose external diameter corresponds to the internal diameter of the housing 5, is pushed in an interlocking manner into the housing 5. This makes it possible to ensure that the winding is held by the cup wall in the event of a slight vibration load, and that no relative movement of the winding is possible. In order to prevent such a relative movement even when there is a severe vibration load, greater pressure forces are required between the winding and the cup and can be produced simply by pushing a winding into a cup. The capacitor winding 10 has areas 10A of a spacer which project upwards, for example a paper layer. Thermal coupling, corresponding to the prior art, between the capacitor winding and the base of the cup-shaped housing may be ensured, for example, by a number of areas 10B of the cathode sheet projecting out of the capacitor winding and making contact with the base of the housing.

FIG. 2B shows how additional pressure forces can be formed between the winding and the cup wall by producing additional fixing elements, in the form of depressions 40B, so-called beads, in the housing in an additional, advantageous method step A1), which beads pinch the capacitor winding.

FIG. 2C shows how the winding which has been pressed into the cup is impregnated with a solution, for example with the electrolyte solution, and in the process expands (method step B). In this case, strong pressure forces are exerted by the winding on the cup wall, which are strong enough to prevent any movement of the winding relative to the housing even in the event of severe vibration. The depressions 40B which were incorporated before the impregnation process in this case further reinforce these pressure forces.

FIG. 2D shows a variant of the method step C) according to the invention. In this case, the cover 15 is fitted to the capacitor winding 10 such that slight pressure forces from the cover act on the capacitor winding, and the capacitor winding is also braced between the cover and the base of the cup, in addition to the bracing which is already provided between the cup wall. In this case, the projecting areas 10A of the spacer are, in particular, pinched. This makes it possible to prevent the capacitor winding from being able to move horizontally or vertically relative to the housing in the event of severe vibration. The electrical connections 20 which are electrically conductively connected to the capacitor winding are firmly connected to the cover. Metal strips are generally connected to the electrical connections and additionally make contact with the anode sheets of the capacitor winding.

FIGS. 3A and 3B show a schematic cross section through and a plan view of a further advantageous embodiment of the capacitor according to the invention. As can be seen, fixing elements 45 which in this case are in the form of ribs which project into the interior of the housing and fix the capacitor winding 10 horizontally in the housing are provided in this case. In this case, it is advantageous to use a capacitor winding whose external diameter is equal to the internal diameter of the space which is bounded by the fixing elements in the interior of the housing. This capacitor winding can then be introduced into the housing, and can subsequently be impregnated in the method step B), so that it expands. These fixing elements are advantageously formed by aluminum extrusion-molded parts which may, for example, be shaped in one method step together with the cup using an extrusion molding method.

Areas of the fixing elements which are closest to the cover are advantageously structured such that they have a smaller cross section than other areas of the fixing elements which are further away from the cover, as is shown by way of example in FIG. 3A. This makes it easier to introduce the capacitor winding into the space that is bounded by the fixing elements in the housing.

If the fixing elements are composed of a metal, for example aluminum as stated, this results in even further advantages as shown in the cross section and plan view of FIGS. 4A and 4B. In this embodiment of the capacitor, the fixing elements, the ribs (which at the same time are electrically conductive and also highly thermally conductive) make close mechanical contact with the winding. This therefore provides an additional good thermal contact between the winding and the cup wall, which does not occur with conventional windings. The ribs reduce the thermal resistance from the cup wall to the cup base so that, as is indicated schematically by the arrows, heat can be dissipated between the winding casing the ribs according to the invention. The heat is generally dissipated via a plate 55 on which the capacitor is mounted. The plate is in this case used for heat dissipation and is generally composed of a highly thermally conductive material, for example aluminum sheet. An electrically isolating layer 60, which electrically isolates the capacitor from the plate 55, is generally fitted between the plate 55 and the capacitor. Apart from the additional heat dissipation via the fixing elements to the wall of the capacitor housing, heat dissipation corresponding to the prior art is still possible via the base of the housing, with the already mentioned cathode sheet 10B being used for heat dissipation in this case.

Arrows in the schematic cross section shown in FIG. 5 show those heat dissipation paths which are possible in conventional capacitors. As can be seen, only disadvantageously restricted heat dissipation can take place in this case from the capacitor winding via the cup base, and no additional heat dissipation is possible via the wall of the capacitor housing.

The relatively massive mounting elements, which are in the form of ribs, and advantageously have a greater wall thickness than the wall of the housing 5, furthermore allow the depressions 50 that are shown in FIG. 6 to be incorporated, and these can also be used for mounting the capacitor on the plate 55. For example, it is possible to incorporate blind holes in the base of the housing and in areas of the ribs adjacent to it, which allow the capacitor to be mounted on the plate 55 by means of mounting screws. Furthermore, it is also possible to incorporate a hole and a groove on the side walls of the cup and on areas of the ribs adjacent to them, which can be used to anchor the capacitor in an external mounting system. In the case of conventional capacitors, the lack of fixing elements there makes it very difficult to produce the illustrated depressions 50.

FIG. 7 shows a schematic cross section through a further advantageous embodiment of the capacitor according to the invention. As can be seen, the fixing elements 45 are in this case in the form of ribs extending to the lower edge of the cover 15. This has the advantage that there is no need to produce a contact bead 40A, as is normally done in a separate method step, for the cover 15 to rest on (see FIG. 1A). Furthermore, this design has the advantage that the tolerances on the length of the capacitor are narrower. This has the advantage that capacitors whose length is subject only to very narrow tolerances can be produced in large quantities. This has the advantage that these capacitors can be connected in a so-called capacitor bank between a cooling plate, the plate 55 and a flat contact in the form of a capacitor bank, in which case contact can be made in a particularly simple manner with the electrical connections since the capacitors according to the invention are at the same height.

It is also possible not to lengthen the fixing elements 45 as far as the lower edge of the cover, so that there is an area without any ribs on the inner wall of the housing, to which additional beads 40B can subsequently be fitted in the method step A1) without any problems. Furthermore, these areas of the housing without any ribs also allow the capacitor housing to subsequently be swaged.

The invention is not restricted to the exemplary embodiments and exemplary methods described here. Variations are possible, particularly with regard to the physical shape of the capacitors. For example, it is thus feasible to use other physical shapes instead of screw connection capacitors, for example snap-in, axial, radial (single-ended) capacitors. There are further variation options in the configuration of the fixing elements, and in their arrangement on the inner wall of the housing.

1. A method of producing a capacitor having a housing that includes walls, a base, and a cover on a top of the housing, the method comprising:
inserting, into the housing, a capacitor winding that is longer than a distance between the base and a lower edge of the cover on the housing, the capacitor winding contacting a wall of the housing;
adding a liquid to the capacitor winding; and
closing the cover over the housing such that the capacitor winding is held in place by force between the cover and the base.

2. The method of claim 1, wherein the housing includes:
fixing elements that assist in holding the capacitor winding in place in the housing.

3. The method of claim 2, wherein the fixing elements bound an outer circumference of the capacitor winding.

4. The method of claim 2, further comprising:
producing the housing together with the fixing elements prior to inserting the capacitor winding into the housing.

5. The method of claim 4, wherein extrusion molding is used to produce the housing and fixing elements.

6. The method of claim 2, wherein the fixing elements comprise ribs that project into an interior of the housing.

7. A capacitor comprising:
a cover; and
a cup-shaped housing having an interior wall that includes fixing elements the fixing elements holding a capacitor winding in the housing, an external diameter of the capacitor winding corresponding to a diameter of an area bounded by the fixing elements, the capacitor winding being longer than a space between a base of the housing and a lower edge of the cover mated to the housing;
wherein the cover mates to the housing such that the capacitor winding is held in place, by force, between the cover and the base of the housing.

8. The capacitor of claim 7, wherein the fixing elements comprise ribs that project into an interior of the housing.

9. The capacitor of claim 7, further comprising additional fixing elements, the additional fixing elements comprising indentations in the housing.

10. The capacitor of claim 7, further comprising:
depressions for mounting the capacitor on a plate, the depressions being substantially adjacent to the base of the housing.

11. The capacitor of claim 7, wherein the fixing elements are arranged only on areas of the interior wall of the housing that are adjacent to the base of the housing.

12. The capacitor of claim 7, wherein areas of the fixing elements that are closest to the cover have a smaller cross section than areas of the fixing elements that are further away from the cover.

13. A capacitor comprising:
a capacitor winding;
a housing having an interior that accommodates the capacitor winding, the housing including one or more interior elements that hold the capacitor in place; and
a cover that fits atop the housing, the cover forcing the capacitor winding in the housing to compress and thereby hold the capacitor winding in place in the housing in an event of movement of the capacitor.

14. The capacitor of claim 13, wherein the one or more interior elements comprise indentations in the housing the contact the capacitor winding.

15. The capacitor of claim 13, wherein the one or more interior elements comprise ribs that protrude from an inner wall of the housing to the interior of the housing.

16. The capacitor of claim 13, wherein the capacitor winding comprises a cathode sheet that projects out from the capacitor winding and that contacts a base of the housing in order to produce thermal coupling between the capacitor winding and the housing.

17. The capacitor of claim 13, wherein the capacitor winding interlocks with a portion of the housing.

18. The capacitor of claim 13, further comprising:
an encapsulating compound at a base of the housing, the encapsulating compound reducing heat dissipation from the capacitor winding.

19. The capacitor of claim 13, wherein the capacitor winding, when not in the housing, has a length that is greater than a distance between a base of the housing and a the cover when the cover is on the housing.

20. The capacitor of claim 13, wherein areas of the one or more interior elements that are closer to the cover have a smaller cross section than areas of the one or more interior elements that are located further away from the cover.
